(19) United States
(12) Patent Application Publication
(10) Pub. No.: US 2022/0374315 A1
(43) Pub. Date: Nov. 24, 2022

(54) COMPUTER BACKUP GENERATOR USING BACKUP TRIGGERS

(71) Applicant: KYNDRYL, INC., NEW YORK, NY (US)

(72) Inventors: Dinesh G. Venkatraman, Bangalore (IN); Pritpal S. Arora, Bangalore (IN); Hariharan N. Venkitachalam, BENGALURU (IN); KALPESH SHARMA, Bangalore (IN)

(21) Appl. No.: 17/323,265

(22) Filed: May 18, 2021

(51) Int. Cl. G06F 11/14; G06F 17/18

(52) U.S. Cl. CPC G06F 11/1464; G06F 11/1451; G06F 17/18

(57) ABSTRACT

Provided is a method for generating a data backup strategy for a computer system. The method comprises receiving an event related to a change in a computer system. The method further comprises applying regression techniques on historical data related to previous events for the computer system to determine a failure prediction score for the computer system. The method further comprises calculating a set of backup parameters for performing a backup of data of the computer system. The method further comprises generating a score for the backup using the set of backup parameters. The method further comprises determining a backup strategy for the computer system based on the score.

### BACKGROUND

The present disclosure relates to generation of computer backup strategy, and more specifically, to a cognitive strategy generator for optimization with backup triggers.

Performing backups of data stored on one or more computers is an often recommended action to prevent data loss. Data loss can be caused by many things ranging from computer viruses to hardware failures to file corruption to fire, flood, or theft, among others. Backing the data up to another device or location allows data to be recovered in the event of a data loss that only affects the primary copy of the data.

### SUMMARY

Disclosed herein are embodiments of a method, system, and computer program product for generating a data backup strategy for a computer system. The method comprises receiving an event related to a change in a computer system. The method further comprises applying regression techniques on historical data related to previous events for the computer system to determine a failure prediction score for the computer system. The method further comprises calculating a set of backup parameters for performing a backup of data of the computer system. The method further comprises generating a score for the backup using the set of backup parameters. The method further comprises determining a backup strategy for the computer system based on the score.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a flowchart of an example method for using a cognitive strategy generator for optimization with backup triggers, in accordance with embodiments of the present disclosure.

FIG. 2 illustrates a flowchart of an example method for determining backup parameters, in accordance with embodiments of the present disclosure.

FIG. 3 illustrates an example computing environment in which illustrative embodiments of the present disclosure may be implemented.

FIG. 4 illustrates a flow diagram of an example execution of one or more methods for generating a backup strategy, in accordance with embodiments of the present disclosure.

FIG. 5 illustrates a set of tables showing location scores, type scores, and timeslot scores for an example data backup, in accordance with embodiments of the present disclosure.

FIG. 6 illustrates a high-level block diagram of an example computer system that may be used in implementing one or more of the methods, tools, and modules, and any related functions, described herein, in accordance with embodiments of the present disclosure.

FIG. 7 depicts a cloud computing environment according to some embodiments of the present disclosure.

FIG. 8 depicts abstraction model layers according to some embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to generation of computer backup strategy, and more particular aspects relate to a cognitive strategy generator for optimization with backup triggers. While the present disclosure is not necessarily limited to such applications, various aspects of the disclosure may be appreciated through a discussion of various examples using this context.

Methods for computer backups (referring to backing up one or more computers, one or more hard drives, one or more folders or files, or any other backup of computer data) can be limited by the strategy employed to perform backups. For example, a lack of a computer backup strategy can lead to a lack of computer backups at all, which in the event of data loss can lead to the inability to restore any data. A computer backup strategy without an implementation or scheduling element can lead to backups not being performed or not being performed in a consistent way such that data loss can be significant if the most recent backup was a significant time in the past or the first backup had not yet been performed (which may be the case for newer created data).

Similarly, the lack of a backup strategy can also lead to creation of too many backups or backups of greater magnitude than necessary. For example, backing up terabytes of data daily can create a significant storage burden as the amount of storage required for backups increases geometrically. While this level of backup can be useful or a good strategy for frequently changing and important data, this level of backup can be a waste of resources if the data remains unchanged or has minimal changes and all the unchanged data is backed up repeatedly. Even when a backup strategy is implemented and performing well, an undetected failure in backups, such that backups have paused or otherwise not been performed, can lead to data loss. As such, generation of a proper strategy for backups can be a critical component of backing up data.

Current techniques for creating and deploying a backup strategy involve a human (such as an information technology (IT) specialist) developing and implementing a strategy. This can involve review of the data to be backed up, the systems involved, available backup programs, predictions for device failure, and any other factors deemed relevant by the IT specialist. This can be a time consuming process and is prone to human error. Additionally, it often results in backup strategies that may be acceptable for some of the data, but unacceptable for other data.

Disclosed herein is a system (referred to herein as a cognitive strategy generator) for deriving backup triggers for data. In some embodiments, the backup triggers may be derived for a hybrid, multi-cloud environment. Unlike traditional systems that rely solely on frequency-based regular backups, some embodiments of the system provide a proactive backup approach based on the predictive health of the system. The backups may be optimized on space saving and/or location and operational efficiencies, and the system may consider data and/or events gathered from various sub-systems in the Enterprise's IT ecosystem to determine the backup plan.

In some embodiments, the backup plan may include self-triggered backup mechanisms (referred to herein as “backup triggers”). When the conditions set by the backup triggers are met, the corresponding data may be automatically backed up. The backup triggers may be based on situational criteria, and may weigh the positives of backing up the data against the negatives. For example, the backup triggers may be based on predictive failures, change induced incidents, the sensitivity and criticality of changes, etc. These factors may be weighed against volume and cost criteria, among others. These negative factors, also referred to herein as backup costs, may be computed on the basis of the volume of data to be backed up, capacity of data to be backed up, type of backup, etc.

In some embodiments, the backups may be integrated into ticketing and/or configurations systems. This may enable aligning backup sequence patterns to ticketing and change patterns. Additionally, this may create prioritization windows for backups. In other words, the schedule of the automated backup trigger can be adjusted based on the patterns derived from the data from the ticketing/configuration systems. For example, in some embodiments, the system can determine if there are any periodic change windows associated to a system that is to be backed up by looking at the pattern from the configuration system and create a window for backing the system up such that it is always before/after the change window is completed.

The generated backup strategy may apply at any level of granularity. For example, some embodiments may determine a backup strategy at the system level, where all data in the system is governed by the same backup strategy. In some embodiments, the backup strategy may apply at different levels, such as the code level, the middleware level, or at an image-based level. In some embodiments, the system may have multiple separate backup policies for each level (and/or for different data within each level), and the backup strategy described herein may be thought of as encompassing all of the individual backup policies. In some embodiments, the system may contain multiple backup strategies.

In some embodiments, the cognitive strategy generator can include an orchestration engine which receives events or messages from systems such as a configuration management database (CMDB), a ticketing system, or any other systems (including enterprise systems) which can indicate a backup may be warranted. The cognitive strategy generator can use an analytical model to apply regression techniques on historical data of messages from these systems and output failure prediction insights. The cognitive strategy generator can also compute risk and criticality scores for one or more pieces of data (e.g., files, folders, drives, etc.) and determine if a backup is needed for a current event or message based on these scores. An optimization engine can determine a location, type, volume, and any other details for the backup based on a series of optimization rules. The orchestration engine can calculate a cost of a backup using a cost calculator component and parameters such as the volume, location, network speed, change type, etc. and recommend the optimal location, type, volume of backup, and any other factors for implementing a backup. The orchestration engine can then trigger backup agents to perform (or schedule for performance) the backup in response to the event. Following the backup, the orchestration engine can trigger assurance checks to verify the accuracy and completion of the backup process and update a feedback engine. The feedback engine can be used to update the optimization rules, and the cognitive strategy generator can use the data from each backup to improve the backup strategy over time.

A system of a cognitive strategy generator for optimization with backup triggers, method of using said system, and a computer program product containing said system or components thereof and as described herein can provide advantages over prior methods of backing up computer systems. As disclosed herein, the cognitive strategy generator can be responsible for developing a strategy for the backup of computer data without need for an IT specialist, and this strategy can depend on the specific situation at hand, the data involved, the cost of potential backups, and all the other factors discussed herein. As such, the strategy generated can be superior to that created by a human, flexible to the needs of the organization using the cognitive strategy generator, and can balance factors such as cost and speed to deliver the optimal level of backup. These improvements and/or advantages are a non-exhaustive list of example advantages. Embodiments of the present disclosure exist which can contain none, some, or all of the aforementioned advantages and/or improvements.

Some embodiments of the present disclosure include a method and system for cognitively deriving backup triggers on a hybrid multi-cloud environment by determining predictive health of a system using a proactive algorithm. More specifically, method may include generating an optimum backup strategy for multi-variate backup features related to location, volumes, file vs configuration backups, full vs incremental backups, historic failures, change-induced incidents, and criticality of changes in an enterprise information technology (IT) system. Furthermore, the method may include building intelligence into a system to predict a need for the backup and an optimal location for highly restorable backup and initiating the backup based on a dynamic assessment of risk and criticality of a business application. Additionally, the method may include triggering the backup based on an optimization of location, environmental change risks, problematic servers along with capacity volume constraints in the hybrid multi-cloud environment.

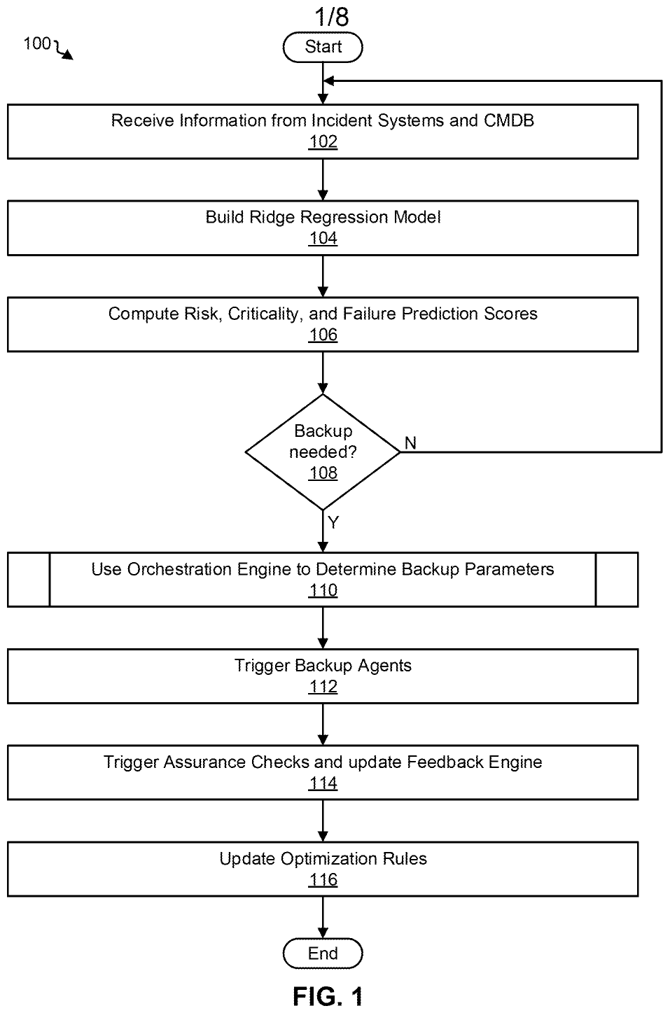

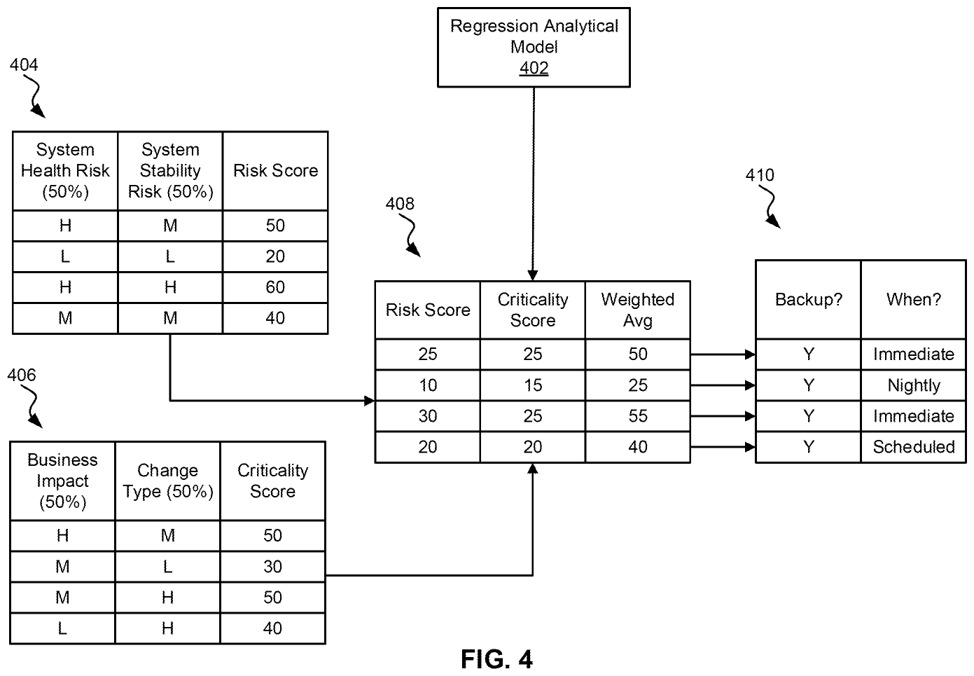

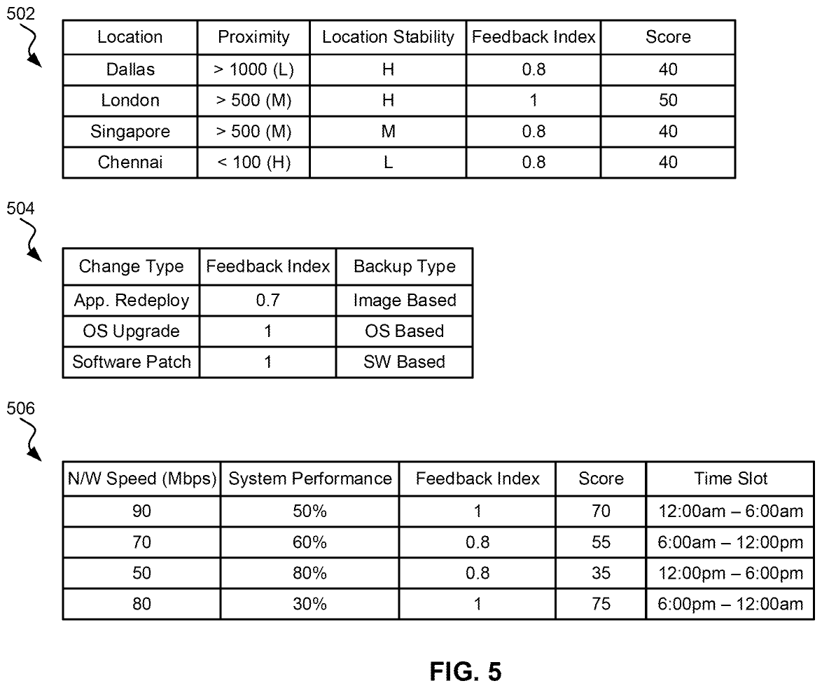

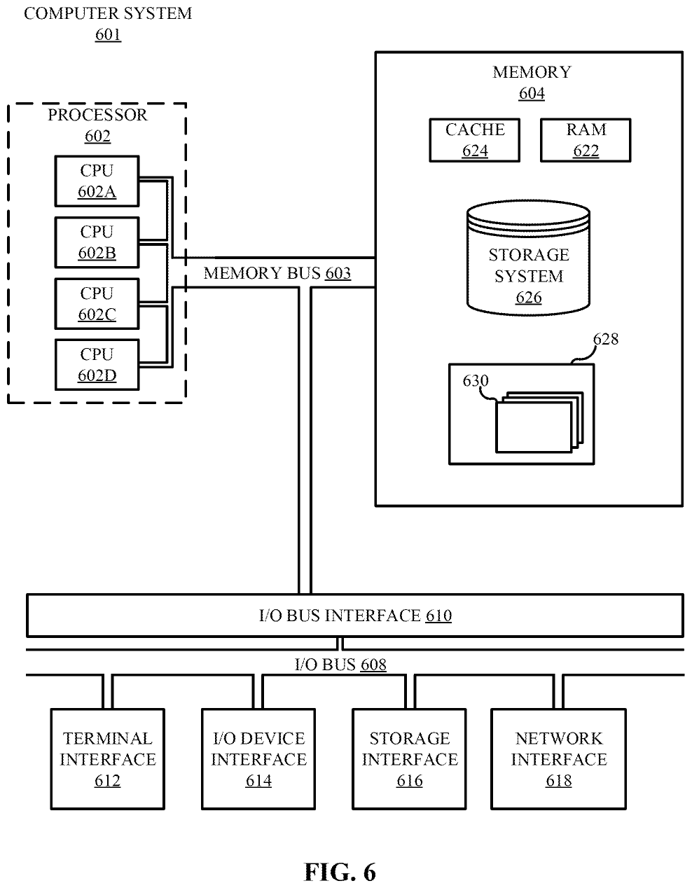

Referring now to FIG. 1, depicted is a flowchart of an example method 100 for using a cognitive strategy generator for optimization with backup triggers, in accordance with embodiments of the present disclosure. The following discussion will refer to the method 100 as being performed by a cognitive strategy generator, or components of a cognitive strategy generator. It is to be understood that the cognitive strategy generator can be implemented by (and, thus, the method 100 performed by) a computer, a collection of computers, one or more virtual machines (including running on a cloud platform), a component of a computer, firmware or other software running on a computer, or a computer program product. In some embodiments, the cognitive strategy generator can be consistent with computer system 400 of FIG. 4 and/or the cloud computing environment 50 of FIGS. 5-6. In some embodiments, the method 100 can be performed with computer data stored on computer system 400 of FIG. 4 and/or the cloud computing environment 50 of FIGS. 5-6, regardless of where the cognitive strategy generator is located. The method 100 can include more or fewer operations than those depicted. The method 100 can include operations in different orders than those depicted, including operations occurring simultaneously.

The method 100 beings at operation 102, where the system receives information from incident systems (such as a ticketing system) and a configuration management database (CMDB). In some embodiments, other systems (including enterprise systems) can be used in addition or in place of either of the incident systems or CMDB. The information can include, for example, an identification of one or more potential problems with enterprise systems (e.g., a database), the data affected by the potential problem(s), what entity is triggering the report (e.g., whether the report is coming from a user or is an automated report from an application), and any other information that is available regarding the potential problem(s).

At operation 104, the system (e.g., the cognitive strategy generator) builds an analytical model (e.g., a ridge regression model) using the received information. The analytical model may employ regression techniques on historical data relating to the messages from the same systems to generate failure prediction insights. For example, the system can predict the failure of servers and devices on the basis of multiple criteria of historic failures using ridge regression. The criteria may include, without limitation, change induced incidents, criticality of changes in the enterprise IT system, and criticality and risk scores.

As one example, the analytical model, after being built and trained, may generate a server failure prediction in accordance with Equation 1:

Server Failure Prediction={SF_{w}*SF+CI_{w}*CII} Equation 1

where SF_{w} is the relative weight for server failures (in percentage), SF is the server failure historic scores, CI_{w} is the relative weight for change induced incidents (in percentage), and CII is the changed induced incidents scores.

At operation 106, the system (e.g., using the optimization engine) computes the risk, criticality, and failure prediction scores, along with an overall score for the system. Based on all of these scores and associated weights, the cognitive strategy generator also determines whether a backup is needed for the current event. As one example, the cognitive strategy generator may compute a risk score in accordance with Equation 2:

Risk Score=SSRC+SHRC Equation 2

where SSRC is the system stability risk classifier and SHRC is the system health risk classifier. The SSRC may come from the ticketing system, and its value may be generated by applying text analytics on the ticketing system to identify the probability of system failures. The SHRC may come from the device management (MDM) or device agent, and its value may be a health score (e.g., retrieved from the MDM) that classifies a system health risk. In some embodiments, a lower score (e.g., a lower SSRC or SHRC value) corresponds to a heathier system. In some embodiments, each classifier (i.e., the SSRC and the SHRC) has a plurality of scores, such as high, medium, or low, which may correspond to numerical scores such as 30, 20, and 10, respectively.

Similarly, in some embodiments, the system may compute a criticality score in accordance with Equation 3:

Criticality Score=BIC+CTC Equation 3

where BIC is the business impact classifier and CTC is the change type classifier. The BIC may come from the corporate asset repository, and its value may be generated based on the impact (e.g., in financial or other terms) of the machine being analyzed. The CTC may come from the CMDB, and its value indicate the impact of the change type of the change indicated in the information received from the CMDB. In some embodiments, each classifier (i.e., the BIC and the CTC) has a plurality of scores, such as high, medium, or low, which may correspond to numerical scores such as 30, 20, and 10, respectively.

Similarly, in some embodiments, the system may compute an overall score in accordance with Equation 4:

Overall Score=S_{w}*FPS+R_{w}*RS+C_{w}*CS Equation 4

where S_{w} is the relative weight for the failure prediction score (e.g., in percentage), FPS is the failure prediction score given by the regression model (e.g., as discussed above with respect to Equation 1), R_{w} is the relative weight for the risk score (e.g., in percentage), RS is the risk score (e.g., as computed by Equation 2), C_{w} is the relative weight for the criticality score (e.g., in percentage), and CS is the criticality score (e.g., as computed by Equation 3).

At decision block 108, the system determines whether a backup is needed. The system may use the scores generated at operation 106 to determine whether a backup is needed. For example, in some embodiments, after calculating the overall score, the system compares the overall score to the backup strategy (e.g., a rules table) to determine whether to back up the system data, and if so, when to back up the system data.

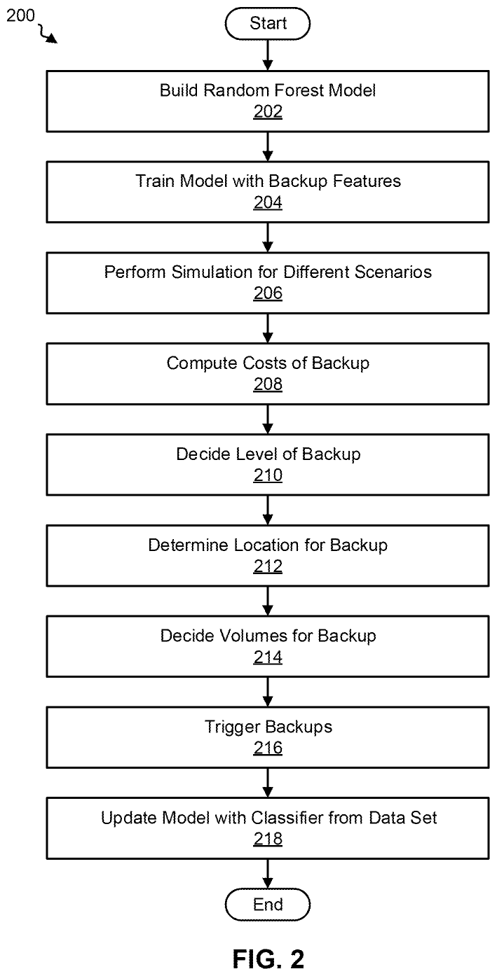

At operation 110, the system (e.g., using the orchestration engine) determines backup parameters. The backup parameters may include, but are not limited to, information related to the backup process, such as the location of the data to be backed up and the location of where the data is to be backed up to, type of backup to perform, when the backup should be performed, and/or the volume of data to be backed up. The backup parameters may further include costs related to the backup. Using the backup parameters, the system generates a recommendation for the backup. Operation 110 can be a sub-process containing multiple sub-operations, such as those described in FIG. 2.

At operation 112, the system (e.g., using the orchestration engine) triggers the backup agents. The backup agents may be installed on the target device, and triggering the backup agents may include causing them to begin backing up the data. In some embodiments, triggering the backup agents does not cause the data to immediately get backed up, but instead may include notifying the backup agents of a future time when the backup should occur. The backup agents may be software, hardware, firmware, or any combination thereof.

At operation 114, the system (e.g., using the orchestration engine) triggers assurance checks and updates the feedback engine. The assurance checks may be a type of checksum on patch deployment. The assurance checks may be used to verify that the backup was successfully completed (e.g., all of the data has been successfully backed up) without data corruption or error. The system may also update the feedback engine on the status of the backup.

At operation 116, the system (e.g., using the feedback engine) updates the optimization rules based on the assurance checks. For example, consider a scenario in which the optimization rule to choose a location has a parameter “location stability.” At the end of each backup, the assurance checks component can run checksum validations to determine the quality of backups taken in the location and send the success/failure data to the feedback engine component. In case of more failures, the feedback engine reduces the location stability for a location from, for example, high to medium and reduces the feedback index which will eventually get applied in subsequent events. The same concept may be applied for all other parameters which influence the optimization rules.

After operation 116, the method 100 ends.

Referring now to FIG. 2, shown is an example method 200 for determining backup parameters, in accordance with embodiments of the present disclosure. The method 200 may be performed by hardware, firmware, software executing on a processor, or any combination thereof. For example, the method 200 may be performed by a processor (e.g., executing an orchestration engine). The method 200 may be performed as part of the method 100. For example, the method 200 may be performed as a subprocess of operation 110 discussed with respect to FIG. 1. The method 200 begins at operation 202, wherein the processor builds a random forest model.

A random forest model is an ensemble learning method for classification, regression and other tasks that operates by constructing a multitude of decision trees at training time and outputting the class that is the mode of the classes (classification) or mean/average prediction (regression) of the individual trees.

At operation 204, the processor trains the random forest model with the backup parameters. In some embodiments, the random forest model is trained using the backup parameters determined at operation 110. In some embodiments, the random forest model may be trained using one or more of the determined locations, types, times, volumes, and environmental stability risks. By training the random forest model using these parameters, the model can then subsequently be used to determine, for a given backup, each of these same parameters. In other words, training the random forest model using data that include the location allows the random forest model to be used to pick an optimal location for future backups.

The location may be the weighted average of the speed of the network between source and target environments, as well as location stability. These values can be determined based on trend analysis. An example of how multiple locations can be compared and scored is shown in table 502 in FIG. 5.

The type may be a direct mapping of the change type and recommended type of backup. Change types can be, for example, redeployment of an app, an operating system upgrade, a software patch, or the like. A backup type can include, for example, an image-based backup, an operating system based backup, a software based backup, or the like. An example of how change types and backup types can be related is shown in table 504 in FIG. 5.

The times (or backup time) may be the time slots when the backup should occur. The timeslots can be determined based on the average network speed and machine performance during a given time period. For example, the processor may attempt to optimize the backup such that the combination of network speed and system performance is as high as possible. An example of how network speed and system performance can be scored to determine a timeslot to perform a backup during is shown in table 506 in FIG. 5.

The volume may be the appropriate volume of the disks/devices at the target environment. In other words, the volume that the random forest model is trained using is the set of devices (e.g., storage devices) that will receive the backed up data.

The environmental stability risks are risks associated with system failures. In other words, the random forest model may be trained to consider the likelihood that the target system (i.e., the system that the backup will be performed to) will experience a failure.

At operation 206, the processor performs a simulation for different scenarios. The simulations may be performed using various “what if” scenarios. For example, the scenarios may include situations such as “an application patch installation on a machine in a particular data center.”

At operation 208, the processor computes costs of the backup. As discussed herein, the costs may be computed on the basis of the amount of data to be backed up, the capacity of data to be backed up, the network speed, the type of backup being performed, etc. In some embodiments, the costs may be weighted according to their importance.

At operation 210, the processor decides the level of backup to be performed. For example, the backup may be performed at the system level, the code level, the middleware level, the image level, etc. This is also referred to herein as the “type” of backup. As shown in the example in FIG. 5, the level of backup may be determined based on the type of change(s) that occurred to the system. As an example, when the processor receives a change event from the configuration system which is about applying a specific software patch upgrade in a system, the processor chooses not to trigger an entire OS level back up, which may be overkill for this change. Instead, the processor may restrict backup recommendations only to the specific software which is impacted by the patch installation.

At operation 212, the processor determines a location for the backup. As discussed herein, the location may be based on the average network speed between the source and target systems or environments and locations stability. In some embodiments, the location can be determined using trend analysis.

At operation 214, the processor decides one or more volumes for the backup. As discussed herein, the volumes are the disks and devices that will store the backups. Depending on the backup type, the volume of the backup can also be determined. For example, if the backup type is at the software level (e.g., triggered by a software patch installation), the backup volume will be in the lower side when compared to a backup triggered as a result of an OS upgrade. In other words, the amount of data backed up will generally be less for a software level backup triggered by installation of a software patch than for a backup related to an OS upgrade.

At operation 216, the processor triggers the backups. Operation 216 may be substantially similar or identical to operation 122, wherein the backup agents are triggered.

At operation 218, the random forest model is updated. In some embodiments, the model is updated using historic datasets of backups. In some embodiments, information about the backups triggered at operation 216 may be fed back into the random forest model to update the model. After the random forest model is updated at operation 218, the method 200 ends.

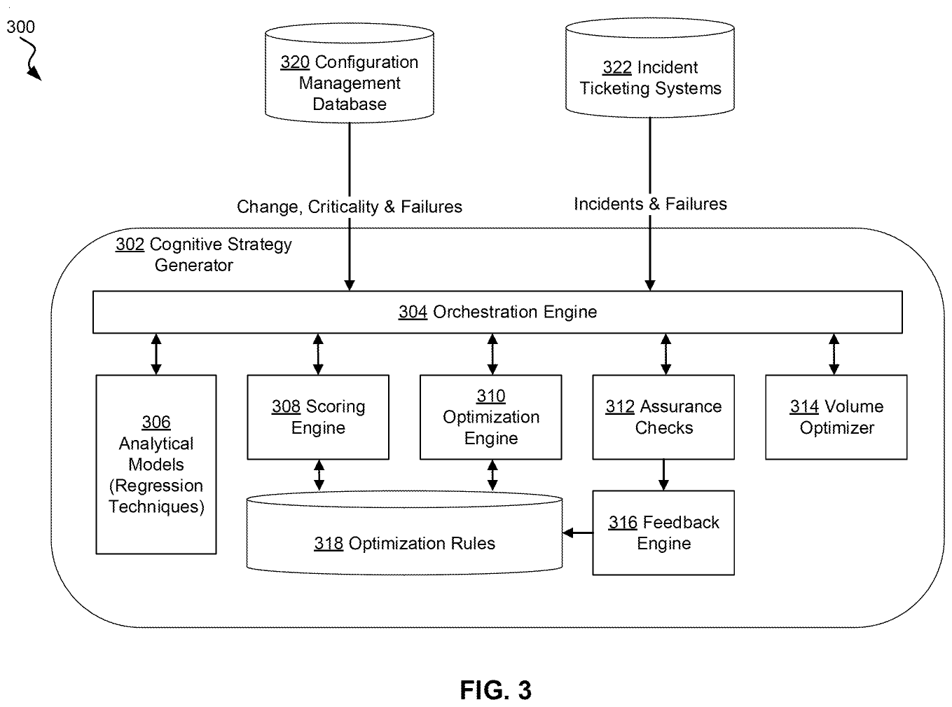

Referring now to FIG. 3, shown is an example computing environment 300 in which illustrative embodiments of the present disclosure may be implemented. The computing environment 300 includes a cognitive strategy generator 302, a CMDB 320, and one or more incident ticketing systems 322.

The CMDB 320 includes information related to changes performed on a system (e.g., software patches), criticality information (e.g., business impact(s) of the system), and failure information. The incident ticketing systems 322 contain information related to incidents and failures reported for the system.

The cognitive strategy generator 302 may be a set of computer modules used to generate a backup strategy for a system. The cognitive strategy generator 302 may be communicatively coupled to the CMDB 320 and the incident ticketing systems 322. The cognitive strategy generator 302 may include numerous submodules and data structures, including an orchestration engine 304, analytical models 306, a scoring engine 308, an optimization engine 310, assurance checks 312, a volume optimizer 314, a feedback engine 316, and one or more optimization rules 318.

As discussed herein, the orchestration engine 304 receives events/messages from enterprise systems such as the CMDB 320 and the ticketing systems 322. The events/messages received are then analyzed to determine whether they warrant performing a backup. This is done by applying the analytical models 306, which use regression techniques on historical data of messages from these systems (e.g., the CMDB 320 and ticketing systems 322) to generate failure prediction insights. In some embodiments, the analytical models 306 may generate a server failure prediction as discussed above with respect to operation 104 and using Equation 1. The scoring engine 308 then computes risk and criticality scores (e.g., using Equations 2 and 3 discussed above with respect to operation 106) and determines if a backup is needed for the current events/messages based on all these scores and weights (e.g., using Equation 4 discussed above with respect to operation 106).

If a backup is needed, the optimization engine 310 determines the location, type, volume, etc., based on the optimization rules 318. This may be done in substantially the same way described in operations 210-214 of FIG. 2. The orchestration engine 304 then calculates the cost of backing up the system data using a cost calculator component (not shown). The cost calculator component uses parameters like volume, location, network speed, change type etc. to calculate the costs of backing up the data. The cost of backing up the data may be calculated in substantially the same way described in operation 208 of FIG. 2.

The orchestration engine 304 then recommends the optimal (e.g., best known given the parameters and optimization rules 318, but not necessarily best possible) location, type, and volume of the backup. The orchestration engine 304 then triggers the backup agents installed in the target device if the backup is needed for an incoming event. Triggering the backup agents may be done in substantially the same way as discussed in operation 112 of FIG. 1. Once the backup is done, the orchestration engine 304 triggers assurance checks 312, which are a kind of checksum on post and pre patch deployment to determine whether the backup was successful. The orchestration engine 304 then updates the feedback engine 316 based on the assurance checks 312. The feedback engine 316 then updates the optimization rules 318 based on the assurance checks 312.

Referring now to FIG. 4, shown is a flow diagram of an example execution of one or more methods for generating a backup strategy, in accordance with embodiments of the present disclosure. In particular, the flow diagram depicts how the output of a regression analytical model 402 can be combined with risk scores 404 and criticality scores 406 to generated weighted scores 408, which are then converted into corresponding backup actions 410.

The table of risk scores 404 shows the risk scores for various scenarios. In particular, risk scores are shown for scenarios where the system health risk ranges from low (L) to medium (M) to high (H), and where the system stability risk ranges from low (L) to medium (M) to high (H). In this example, risk scores for each component (the system health risk and the system stability risk) are weighted equally (50% each), and low, medium, and high are associated with a score of 10, 20, and 30, respectively. A combined risk score (in the third column labeled “Risk Score”) shows to total risk score for the scenario. The combined risk score may be calculated using any weighted combination, such as a weighted sum or weighted average, of the individual risk scores.

The table of criticality scores 406 shows the criticality scores for various scenarios. In particular, criticality scores are shown for scenarios where the business impact ranges from low (L) to medium (M) to high (H), and where the change type score ranges from low (L) to medium (M) to high (H). In this example, criticality scores for each component (the business impact and the change type) are weighted equally (50% each), and low, medium, and high are associated with a score of 10, 20, and 30, respectively. A combined criticality score (in the third column labeled “Criticality Score”) shows to total criticality score for the scenario. The combined criticality score may be calculated using any weighted combination, such as a weighted sum or weighted average, of the individual criticality scores. Because each individual component in FIG. 4 has the same weight, the combined criticality score is determined by adding the scores (e.g., 10, 20, or 30) for each individual component together. For example, the first row has a high business impact score (30) and a medium change type score (20), resulting in a combined criticality score of 50. However, in other embodiments, any other statistical measurement or value may be used.

The table of weighted averages 408 includes weighted risk scores and weighted criticality scores. In the example shown in FIG. 4, the risk scores and criticality scores are equally weighted. As such, the weighted average of the risk scores is half of their values in table 404, and the weighted average of the criticality scores are half of their values in table 406. A final weighted average for each scenario is then calculated and shown in the third column (labeled “Weighted Avg”). In the example shown in FIG. 4, the weighted average is the sum of the weighted risk score and the weighted criticality score. However, in other embodiments, any other statistical measurement or value may be used.

As shown in the table of backup actions 410, each final weighted average is then associated with a backup strategy. For example, a final weighted average of 65 is associated with a backup strategy of immediately backing up the data. Similarly, a final weighted average of 35 is associated with a backup strategy of performing nightly backups. Finally, a final weighted average of 45 is associated with a schedule backup, which may be done with a higher priority than a nightly backup.

In some embodiments, the failure prediction scores from the regression analytical model 402 may also be included in the weighted average table 408. The failure prediction scores may be weighted and combined with the risk scores and the criticality scores to generate the weighted average scores. For example, the failure prediction scores, risk scores, and criticality scores may all be weighted 33.3% and then combined to generate the final weighted averages.

Referring now to FIG. 5, shown is a set of tables showing location scores, type scores, and timeslot scores for an example data backup, in accordance with embodiments of the present disclosure. Specifically, FIG. 5 includes a location score table 502, a type score table 504, and a timeslot score table 506 for a hypothetical data backup process related to an application patch installation on a source machine in the Chennai data center.

The location score table 502 shows various information that may be used to generate a location score for backing up the data from the source machine in the Chennai data center to a target machine in one of four data centers: the Dallas data center, the London data center, the Singapore data center, and a different machine in the Chennai data center. The information includes a proximity of the target machine to the source machine, a location stability of the target data center, and a feedback index. As used herein, the “feedback index” is a coefficient number determined based on the historical data collected by the feedback engine for each parameter influencing the optimization rule. For example, if we consider location stability as a parameter, in case of no backup failures in a specific location, the feedback index will be 1, whereas any failure will bring down the number below 1. This eventually impacts the overall score for a location.

Using this information, a processor may automatically generate a location score for each target data center. As shown in the location score table 502, the Dallas, Singapore, and Chennai data centers each have a location score of 40, while the London data center has a location score of 50. In this example, the higher a location score, the better. As such, the processor may determine, as part of the backup strategy, that the data from the source machine should be backed up to a machine in the London data center.

The type score table 504 shows various information that may be used to backup type depending on the type of change made. For example, an app redeployment may be associated with an image-based backup type, while an operating system (OS) upgrade may be associated with an OS-based backup and a software patch may be associated with a software-based backup. In the example discussed with respect to FIG. 5, the event that caused the backup to be needed is an application patch installation. As such, the processor may determine, as part of the backup strategy, that a software-based backup is the right type of backup.

The timeslot score table 506 shows various information that may be used to determine when a backup should be performed. The information includes, for a plurality of time slots, an average network speed between the source and target machines in megabits per second (Mbps), a system performance score (e.g., system utilization percentage), and a feedback index. Using this information, a processor may automatically generate a timeslot score for each timeslot being considered. As shown in the timeslot score table 506, the 12:00 am-6:00 am timeslot has a score of 70, the 6:00 am-12:00 pm timeslot has a score of 55, the 12:00 pm-6:00 pm timeslot has a score of 35, and the 6:00 pm-12:00 am timeslot has a score of 75. In this example, the higher a location score, the better. As such, the processor may determine, as part of the backup strategy, that the data should be backed up sometime between 6:00 pm and 12:00 am.

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary. Furthermore, the modules are listed and described illustratively according to an embodiment and are not meant to indicate necessity of a particular module or exclusivity of other potential modules (or functions/purposes as applied to a specific module).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

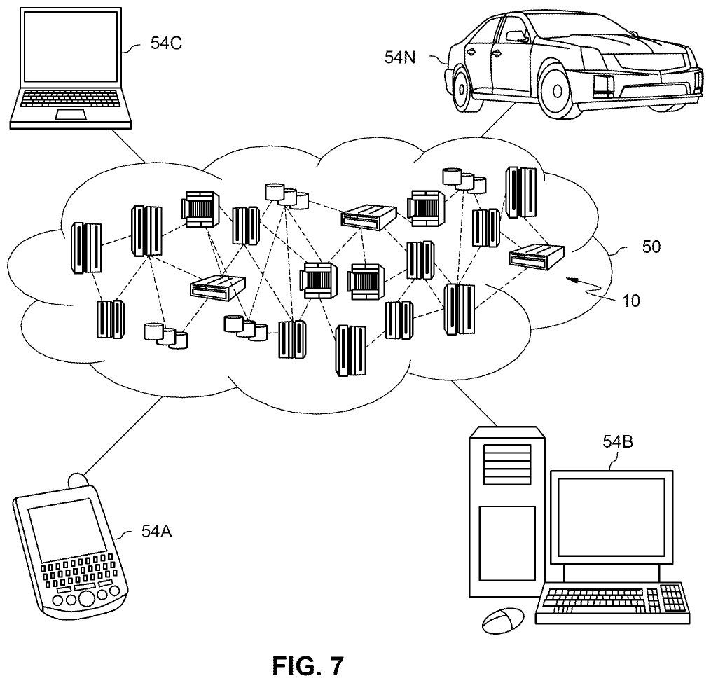

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

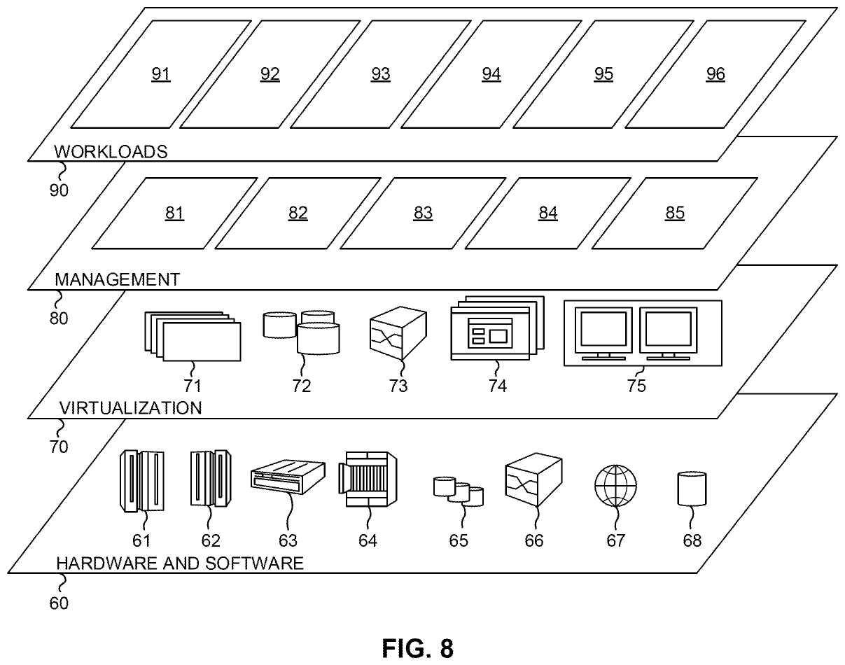

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and backup strategy generator 96. The backup strategy generator 96 may include instructions for performing various functions disclosed herein, such as generating backup strategy for systems based on backup parameters and optimization rules.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications, alterations, and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s). Additionally, it is intended that the following claim(s) be interpreted as covering all such alterations and modifications as fall within the true spirit and scope of the invention.

What is claimed is:

1. A method for generating a data backup strategy for a computer system, the method comprising:
receiving an event related to a change in a computer system;
applying regression techniques on historical data related to previous events for the computer system to determine a failure prediction score for the computer system;
calculating a set of backup parameters for performing a backup of data of the computer system;
generating a score for the backup using the set of backup parameters; and
determining a backup strategy for the computer system based on the score.

2. The method of claim 1, wherein generating the score comprises:
determining a risk score for the computer system, wherein the risk score is based on a system health risk and a system stability risk for the computer system;
determining a criticality score for the computer system, wherein the criticality score is based on a business impact and a type of the change; and
combining the risk score and the criticality score using a statistical analysis technique.

3. The method of claim 2, wherein combining the risk score and the criticality score comprises:
weighting the risk score using a first weight;
weighting the criticality score using a second weight; and
combining the weighted risk score and the weighted criticality score.

4. The method of claim 1, wherein generating the score comprises:
determining a risk score for the computer system, wherein the risk score is based on a system health risk and a system stability risk for the computer system;
determining a criticality score for the computer system, wherein the criticality score is based on a business impact and a type of the change; and
combining the failure prediction score, the risk score, and the criticality score using a statistical analysis technique.

5. The method of claim 1, wherein calculating the set of backup parameters for performing the backup comprises:
determining a level of the backup;
determining a location of the backup, wherein the location relates to a target system that will store the backup data; and
determining costs of performing the backup.

6. The method of claim 1, wherein generating the score comprises generating a plurality of scores, wherein each score corresponds to a different backup scenario, wherein each backup scenario includes a different set of backup parameters, and wherein determining the backup strategy for the computer system comprises selecting the backup scenario that has the best score as the backup strategy.

7. The method of claim 1, wherein the computer system is in a hybrid cloud environment.

8. A system for comprising:
a memory; and
a processor communicatively coupled to the memory, wherein the processor is configured to perform a method comprising:
receiving an event related to a change in a computer system;
applying regression techniques on historical data related to previous events for the computer system to determine a failure prediction score for the computer system;
calculating a set of backup parameters for performing a backup of data of the computer system;
generating a score for the backup using the set of backup parameters; and
determining a backup strategy for the computer system based on the score.

9. The system of claim 8, wherein generating the score comprises:
determining a risk score for the computer system, wherein the risk score is based on a system health risk and a system stability risk for the computer system;
determining a criticality score for the computer system, wherein the criticality score is based on a business impact and a type of the change; and
combining the risk score and the criticality score using a statistical analysis technique.

10. The system of claim 9, wherein combining the risk score and the criticality score comprises:
weighting the risk score using a first weight;
weighting the criticality score using a second weight; and
combining the weighted risk score and the weighted criticality score.

11. The system of claim 8, wherein generating the score comprises:
determining a risk score for the computer system, wherein the risk score is based on a system health risk and a system stability risk for the computer system;
determining a criticality score for the computer system, wherein the criticality score is based on a business impact and a type of the change; and
combining the failure prediction score, the risk score, and the criticality score using a statistical analysis technique.

12. The system of claim 8, wherein calculating the set of backup parameters for performing the backup comprises:
determining a level of the backup;
determining a location of the backup, wherein the location relates to a target system that will store the backup data; and
determining costs of performing the backup.

13. The system of claim 8, wherein the computer system is in a hybrid cloud environment.

14. The system of claim 8, wherein generating the score comprises generating a plurality of scores, wherein each score corresponds to a different backup scenario, wherein each backup scenario includes a different set of backup parameters, and wherein determining the backup strategy for the computer system comprises selecting the backup scenario that has the best score as the backup strategy.

15. A computer program product comprising a computer readable storage medium having program instructions embodied therewith, the program instructions executable by a computer to perform a method comprising:
receiving an event related to a change in a computer system;
applying regression techniques on historical data related to previous events for the computer system to determine a failure prediction score for the computer system;
calculating a set of backup parameters for performing a backup of data of the computer system;
generating a score for the backup using the set of backup parameters; and
determining a backup strategy for the computer system based on the score.

16. The computer program product of claim 15, wherein generating the score comprises:
determining a risk score for the computer system, wherein the risk score is based on a system health risk and a system stability risk for the computer system;
determining a criticality score for the computer system, wherein the criticality score is based on a business impact and a type of the change; and
combining the risk score and the criticality score using a statistical analysis technique.

17. The computer program product of claim 16, wherein combining the risk score and the criticality score comprises:
weighting the risk score using a first weight;
weighting the criticality score using a second weight; and
combining the weighted risk score and the weighted criticality score.

18. The computer program product of claim 15, wherein generating the score comprises:
determining a risk score for the computer system, wherein the risk score is based on a system health risk and a system stability risk for the computer system;
determining a criticality score for the computer system, wherein the criticality score is based on a business impact and a type of the change; and
combining the failure prediction score, the risk score, and the criticality score using a statistical analysis technique.

19. The computer program product of claim 15, wherein calculating the set of backup parameters for performing the backup comprises:
determining a level of the backup;
determining a location of the backup, wherein the location relates to a target system that will store the backup data; and
determining costs of performing the backup.

20. The computer program product of claim 15, wherein the computer system is in a hybrid cloud environment.
